(19) United States
(12) Patent Application Publication
(10) Pub. No.: US 2001/0030232 A1
(43) Pub. Date: Oct. 18, 2001

(54) System and method for validation of packing and shipping operations using two-dimensional bar codes

(76) Inventor: John T. Piatek, Traverse City, MI (US)

Correspondence Address: Price, Heneveld, Cooper, DeWitt & Litton, 695 Kenmoor, S.E., Post Office Box 2567, Grand Rapids, MI, 49501, US

(21) Appl. No.: 09/802,236

(22) Filed: Mar. 8, 2001

Related U.S. Application Data
(60) Provisional application No. 60/187,797, filed on Mar. 8, 2000.

(51) Int. Cl. G06F 17/60

(52) U.S. Cl. 235/375; 705/1

(57) ABSTRACT

A packing and shipping verification system and method operates in real-time to virtually eliminate human error. Machine-readable labels are applied to components (e.g., parts) as they are produced. The label on each component is scanned immediately prior to packing into a container thereby allowing a processing unit to verify and record packing operations. Packing errors are reported in real-time so that they are corrected before a label is generated and affixed to the packing container. After container packing is completed, the processing unit causes a label to be generated that is applied to the container in real-time. A similar process is followed when small containers are placed into larger containers. Every operation is verified by machine scanning of the labels. Labels for containers are only generated after proper packing has been verified by the processing unit. Downstream users scan the labels to extract component information.

### CROSS-REFERENCE TO RELATED APPLICATIONS

The Applicant herein claims the benefit of priority under 35 U.S.C. §119(e) to U.S. Provisional Application No. 60/187,797 entitled, “SYSTEM AND METHOD FOR VALIDATION OF PACKING AND SHIPPING OPERATIONS USING TWO-DIMENSIONAL BAR CODES” which was filed on Mar. 8, 2000 by John T. Piatek, the entire disclosure of which is hereby incorporated by reference.

### BACKGROUND OF THE INVENTION

The present invention generally relates to a system and method for validation of packing and shipping.

Many suppliers have experienced problems in improperly identifying shipments with incorrect labels or placing product in shipping containers designated for a different product resulting in product being sent out of the plant with incorrect labels. For example, a shipment may be sent to the wrong customer, resulting in the shipment becoming lost and never returned. At a minimum, there is the wasted expense of shipping to the incorrect customer plus the return shipping costs. Further, this often results in a delay in the product arriving at the correct customer. Customers become aggravated by these delays.

Problems also arise when a shipment is incorrect. For example, a shipment may have too few or too many parts or have the wrong parts. In the first instance, a customer may be inconvenienced and the manufacturer may incur additional shipping costs to correct the error. In the second instance, the manufacturer does not inconvenience the customer, but is not paid for the excess parts.

Yet another problem is when a downstream user needs information regarding a component. Finding the needed information is often time consuming and requires contacting the manufacturer, etc.

These are just a few of the costly inefficiencies that plague many manufacturers, shippers, and downstream users.

Most attempts at manual fixes to these problems have proven to be very labor intensive while still allowing errors to occur. As a result, many manufacturers and shippers continue to be plagued with packing and shipping errors and downstream users lack needed component information.

Accordingly, it is therefore desirable to provide for a solution that significantly reduces or eliminates these problems.

### SUMMARY OF THE INVENTION

It is an aspect of the present invention to provide a system for readily validating the products (e.g., parts) placed in shipping containers and the shipments themselves in an essentially fail-safe manner. It is another aspect of the present invention to provide a validation system for packing and shipping operations that may be performed without increasing the amount of labor required or adding significantly to the cost of the packing and shipping operations. It is yet another aspect of the invention to provide part, product, or component information to downstream users.

To achieve these and other aspects and advantages, the validation method of the present invention comprises various combinations of the following steps.

The process begins by applying a label containing a two-dimensional symbol or portable data file on each product to be packed in a box. The label contains at least one piece of descriptive data and preferably several types of descriptive data as described below. Immediately prior to the time the product is packed in a box and the label is scanned. The information scanned from the label is communicated to a host processor where the processor automatically verifies that the product is correctly being packed in the box based upon the information contained in the product label. If the product to be packed is not being packed in the correct box or if the product is not the correct product, the system notifies the packing operator and the error is corrected. If the product is being correctly packed in the box, the host processor increments a product count.

The system determines whether the product count for the box has reached a predetermined limit. If the product count for the box has not reached the predetermined limit, then the process starts over by scanning the label on another product to be packed in the box. When the product count for the box reaches the predetermined limit, a label is printed for the box. The label preferably contains some of the product specific data scanned from the product labels packed in the box. The label is immediately applied to the box to reduce the chance of labeling error.

The process continues with the next phase of the packing and shipping operation where the previously packed boxes are packed into larger containers, crates, pallets, or the like. The process for packing the boxes is similar to the process for packing the product. First the label on a box is scanned just prior to the time the box is packed into the larger container. Each box is automatically verified, based on information contained in the label, that the box is being correctly packed in the pallet/container. If the box is not being packed correctly in the pallet/container the packing operator is notified and the error corrected. A box count for the pallet/container is incremented if the box is correctly packed in the pallet/container. When the box count reaches a predetermined limit, a label is printed for the pallet/container. The label preferably contains information scanned from the box labels on the boxes packed in the pallet/container. If the box count has not yet reached the predetermined limit, the process repeats by scanning the label on another box to be packed in the pallet/container. In some embodiments, the product counter may be reset to zero and the process started over by scanning the next label on a product to be packed in a box. When the pallet/container packing process is complete a pallet/container label is generated. The pallet/container label is applied to the pallet/container immediately to eliminate mislabeling errors. The process continues by resetting the box count to zero and repeating the steps above as required.

These and other features, advantages, and objects of the present invention will be further understood and appreciated by those skilled in the art by reference to the following specification and appended drawings.

### BRIEF DESCRIPTION OF THE DRAWINGS

In the drawings:

FIG. 1 is a block diagram of a system for reading and printing two-dimensional bar code labels in accordance with the present invention; and

FIGS. 2A and 2B are flowcharts illustrating the flow of events according to a first aspect of the inventive method.

### DETAILED DESCRIPTION OF THE PREFERRED EMBODIMENTS

As mentioned above and explained in more detail below, the present invention relates to a system and method for validating packing and shipping operations.

Although the preferred implementation of the method is described below with respect to two-dimensional symbologies, other forms of machine-readable data may be used. The machine-readable data encoded on the labels may take many different forms. For example, the machine-readable data may be contained in a radio frequency (RF) or infrared (IR) signal transmitted from a transmitter attached to the label, or may be stored in electronic or magnetic data that may be retrieved using an appropriate reading device. Hence, the labels may include an RF or IR transmitter, smart card, smart button, or RF identification chip. Preferably, the machine-readable data is presented in the form of two-dimensional symbology, such as PDF417 or Data Matrix.

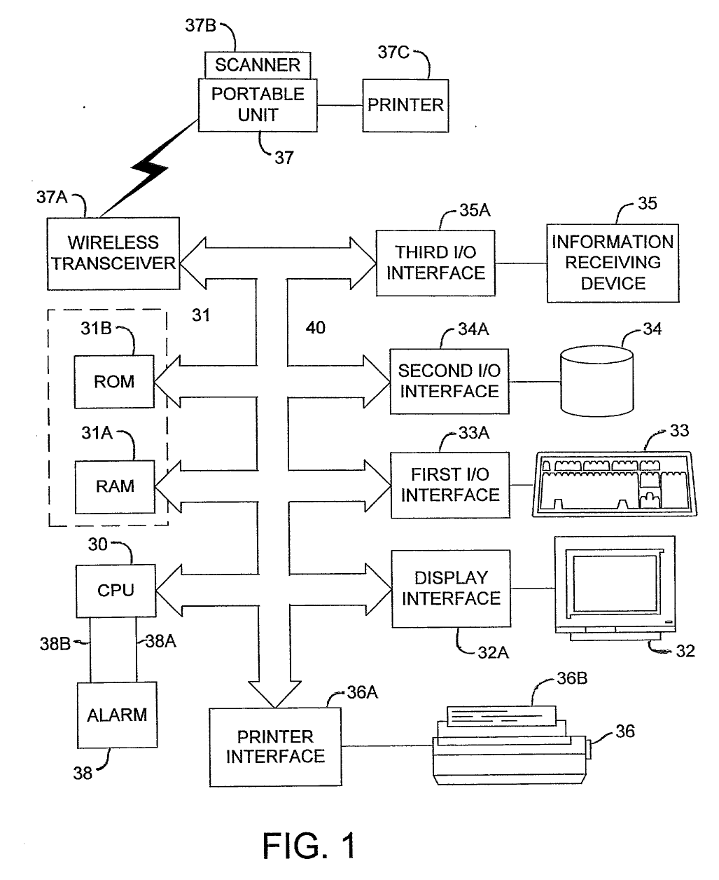

FIG. 1 shows an example of one computer hardware system (or “host system”) 20 that may be used, in whole or in part, to implement the various embodiments of the verification system of the present invention. As shown in FIG. 1, computer hardware system 20 includes a central processing unit (CPU) 30; memory 31, including random access memory (RAM) 31A and read only memory (ROM) 31B; a display monitor 32; a display interface 32A connected to display monitor 32; a data storage device 34; a second input/output (I/O) interface 34A connected to data storage device 34; a keyboard 33; a first I/O interface 33A connected to keyboard 33; an information receiving device (i.e., scanner) 35 connected to a third I/O interface 35A; a printer 36; a printer interface 36A connected to printer 36; a portable unit 37 having a scanner 37B and an optional printer 37C; a wireless transceiver 37A in communication with portable unit 37; and a system bus 40 for interconnecting CPU 30, memory 31, display interface 32A, first I/O interface 33A, second I/O interface 34A, third I/O interface 35A, and printer interface 36A.

Information receiver 35 may be any appropriate type of input device for receiving data from the particular form of machine-readable data used for a particular embodiment or for receiving machine-recognizable information that may be processed by a computer. Preferably, receiving device 35 is a two-dimensional bar code scanner capable of scanning PDF417 or Data Matrix compatible bar codes. However, those skilled in the art understand that other types of input devices may also be used in place of bar code scanners to practice the invention. Some of the various alternative technologies were mentioned above. In this specification, the term “scan” is used to refer to inputting or reading data from a label or other structure using any of these technologies.

In FIG. 1, information receiving device 35 is shown with a wired connection to system bus 40 via third I/O interface 35A. Receiving device 35 is either a fixed (i.e., non-moving) automatic scanner or a handheld manual scanner used by packing personnel. The movement of these receiving devices 35 is limited by the wire connection which keeps them tethered in a limited area. Therefore, it is envisioned that many embodiments of the invention will use a wireless device such as portable unit 37.

Portable unit 37 is a hand-held device having an attached scanner 37B and possibly an attached printer or labeling device 37C. Portable unit 37 is in wireless communication with system bus 40 via wireless transceiver 37A. The mobile convenience of portable unit 37 allows an operator to roam around a plant or even to a warehouse. It is envisioned that large facilities would have multiple portable units 37 used for tracking shipping operations throughout the facility. Numerous embodiments are possible to implement portable unit 37. One embodiment is to use personal digital assistants (PDAs); such as the hand-held units based on those manufactured by Palm, Inc. of Santa Clara, Calif. The units are equipped with a scanner and wireless communications options.

Preferably, data storage device 34 is a computer hard disk drive or an application residing on the Internet. Depending on the complexity of the packing operations, storage device 34 may store vast amounts of data and a sophisticated software program. Storage device 34 stores data such as packing lists, shipping lists, parts lists, part numbers, serial numbers, manufacture dates and revision numbers, date and time of manufacture, line number, shift number, lot ID code, and other like information. One aspect of the invention is that much data can be stored in the labels applied to the components and containers, thus reducing the need for storing data on storage device 34 and enabling data to be shipped with the product. Storage device 34 communicates with CPU 30 via second I/O interface 34A and system bus 40.

Memory 31 includes both RAM 31A and ROM 31B which store the program data and variables used by CPU or host processor 30. For example, RAM 31A holds the various counters such as parts counters, box counters, and the like. These counters are incremented by processor 30 as parts are packed into boxes. Counters could also be implemented in registers or memory internal to processor 30. In some embodiments a simple counter is not sufficient. This is the case when a multitude of various parts must be packed into a box. In this case a packing list is more appropriate since each part on the packing list can be electronically checked-off as the parts are packed. The packing process is complete and verified when all of the parts on the packing list have been scanned and packed. Then, and only then, processor 30 sends a command to a printer 36 to generate a label 36B that is immediately applied to the box.

As mentioned above, the invention alerts the packing operator when a part is being packed in error. This alert is achieved in a variety of ways including: displaying a message on the monitor 32, disabling scanner 37B, or preventing operation of printer or labeling device 36 or 37C. However, it is preferred to have an alarm 38 such as a visual alarm or more preferably an audible alarm to alert a packing operator. Alarm 38 is activated by processor 30 via alarm signal 38A. The alarm generating device may be incorporated into portable unit 37. Similarly, the invention alerts the packing operator when the packing process is complete. This is also achieved in a variety of ways, but the two most preferable methods are: 1) to generate a label 36B, and 2) to activate a visual or audible alarm 38. Processor 30 activates the alarm via the done signal 38B communicated to alarm 38.

As will be apparent to those of ordinary skill in the art, the components of computer hardware system 20 may be incorporated into a personal computer or a portable laptop computer, with the possible exception of information receiver 35 and printer 36. Also, much of the components of the hardware system may be integrated into a small handheld mini-computer having an integral scanner and display. However, as will become apparent from the following description of the present invention, certain components of computer hardware system 20 may be eliminated depending upon the manner in which it is used within the confines of the present invention. For example, if computer hardware system 20 were used solely for producing and storing the data carried on the package (e.g., generating labels), information receiver 35 may be eliminated. On the other hand, if computer hardware system 20 were used solely for receiving data (e.g., scanning labels) and displaying the received data on a display, keyboard 33 may be eliminated and printer 36 would become optional, unless one wished to print out information displayed on display monitor 32. By eliminating keyboard 33 and/or printer 36, computer hardware system 20 may be implemented in a very portable, small integral device.

For example, for a downstream user who merely desires to read the component or container data on a label, a portable handheld unit equipped with a scanner and a display screen may be sufficient.

Clearly, the particular form taken by computer hardware system 20 will depend upon the manner and environment in which the system is used. Further, computer system 20 may also be configured with a cellular telephone, a global positioning system (GPS), digital camera, facsimile machine, image scanner, or fax/modem.

Having described the host system hardware, the details of the method are described further below.

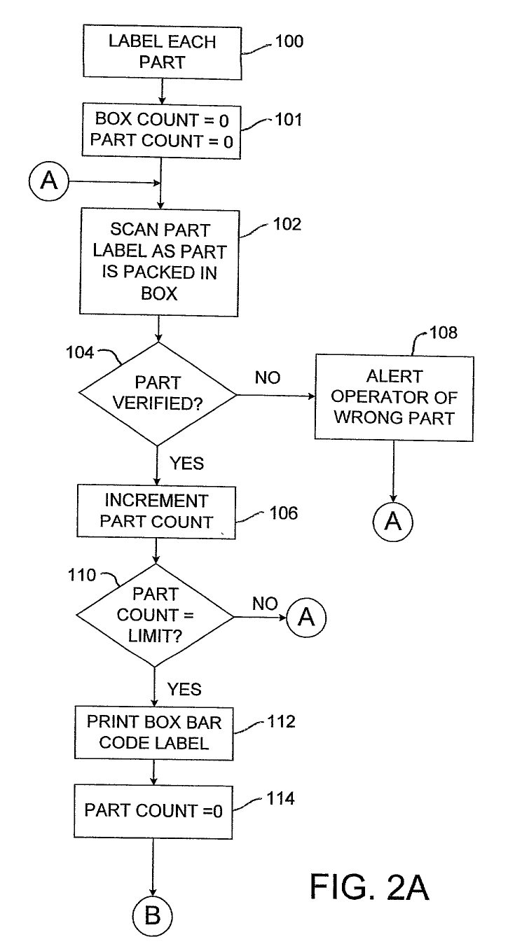

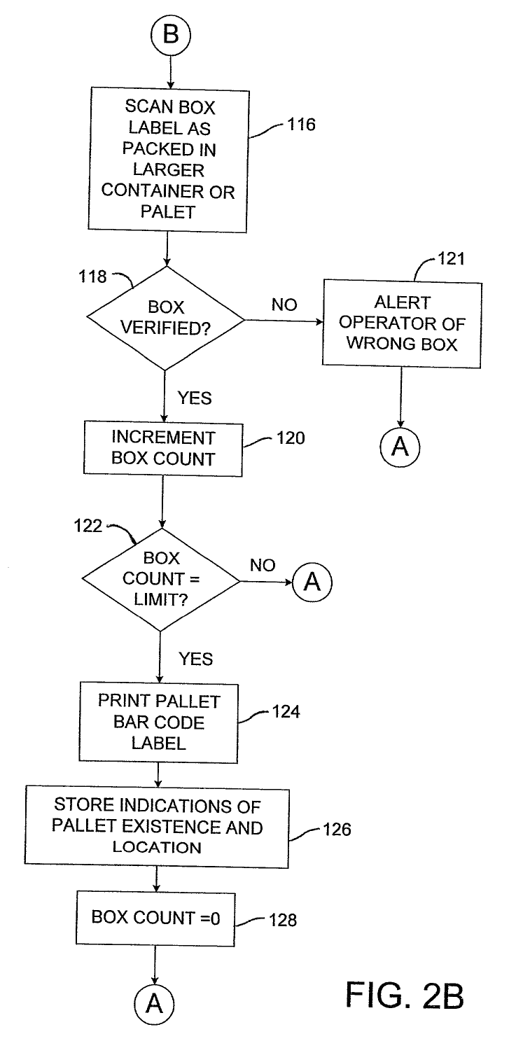

As indicated in block 100 of FIG. 2A, the inventive process begins by labeling each part or product to be packed and shipped with a two-dimensional bar code that contains, preferably, at least the current part number. The bar code may also include the unique serial number (if applicable), date of manufacture, and current revision level. Other optional information that could be included in the bar code are date and time of manufacture, line number, shift number, lot identification code, and other similar applicable information. It is also envisioned that some embodiments will use a bar code or label containing only one or two items of data from those listed above or similar data.

In block 101, the host system 20 initializes box and part counters to zero. Then, as depicted in block 102, as each part/product is packed, the two-dimensional bar code on the part is scanned with a bar code reader (such as reading device 35) to identify to host system 20 that the part is being placed in a box or package. Host system 20 then verifies the correct part is being packed in the box (block 104). If the part is correct, host system 20 increments the part count by one (block 106). In the alternative, some embodiments use a packing list instead of a counter. As parts are packed, processor 30 electronically tracks the parts that are packed and compares the parts packed to a packing list. If the part is not the type of part that is to be packed in the box, host system 20 alerts the operator that the part is incorrect (block 108). As indicated by block 110, this process (steps 102-108) is continued until the correct part count has been reached and all the parts packed have been verified that they are the correct parts for the box. Then, as indicated in block 112, host system 20 automatically produces the label for the box. This label is immediately applied to the box by an operator or by an automatic labeling device. As indicated in block 114, the host system then resets the part counter for the next box to zero, and the process then either repeats itself or proceeds to step 116 (FIG. 2B).

If the box is to be packaged as part of a larger box, container, crate, or pallet, each box label is scanned as it is being placed into the larger container (block 116). Host system 20 will again verify the correct box of parts is being packed in the correct container (block 118) and keep a current box count (block 120). If the wrong box is being packed in the container/pallet, host system 20 alerts the operator (block 121). Once the correct box count (standard pack size) has been reached (block 122), host system 20 will automatically print a pallet label applicable to the type of parts and package being packed (block 124). This label is immediately applied to the pallet or container by an operator or by an automatic labeling device. Host system 20 will record the availability and existence of the pallet/container in tables that it stores in its memory (block 126) and the box count is reset (block 128) and the process is repeated.

A box, container, or pallet can be relocated to a warehouse or shipping area by scanning the associated bar code, which will automatically update host system 20 so that it will know the current location of each part, box, container, or pallet.

One can easily understand that the invention may be extended throughout the packing and shipping process. Parts are labeled and scanned before they are packed into boxes. Boxes are labeled and scanned before they are packed into larger boxes or containers. The larger boxes and containers are labeled and scanned before they are loaded into or onto shipping crates or pallets. Finally, the crates and pallets are labeled and scanned before they are loaded onto trucks, trailers, railroad cars, and the like. Every step of the process is monitored and verified by the host system.

To facilitate error-free shipping, software in host system 20 is used to assign specific pallets to be shipped to a customer against a specific shipping order based on available product at hand. Host system 20 then instructs the operator via a radio frequency (RF) terminal or by printing out a two-dimensional bar coded ship list (if the system is not RF) to pull and scan specific boxes by serial number or similar identifier. If the correct serial numbers are then scanned by the operator as he or she pulls them, the data collection device will verify the correctness of the boxes loaded for this shipment. If pallet serial numbers are the ones that are correct for the order, the host system software will verify and generate a pallet label immediately from the portable printer possessed by the person who scanned the pallet. The label will be immediately affixed to that pallet by the operator. The host system software will then assign this serial number as ready for shipment. This process is repeated until the order for the customer is fulfilled. Upon filling the order, the host system may generate a master pallet label, if necessary. Software will continuously monitor the scanning process to verify that proper labels have been scanned. Upon completion of an order, the same verification process used for packing may be applied to loading a truck with a shipment to a customer.

To facilitate a foolproof inventory management and error-proof shipping and labeling system, the proposed system preferably mandates the use of two-dimensional bar codes to mark individual parts. All transactions are reported to the host system by bar code scan. Manual entry is prohibited except for rare exceptions. Further, it is desirable that labels are not preprinted, but rather are printed only when the process that is being performed is verified by the host system to be correct. By using this model, the human factor for error is absolutely minimized or removed. This system relies on the host system to provide instructions, interpret bar codes, verify that correct parts are being packaged, and the printing of the proper labels for the shipment as a system-controlled process. Labels are preferably only printed when the host system determines that the reported information has been verified as correct. If it is not, a label is not printed.

The system described here will work with batch data collection terminals (e.g., terminals wired to the system bus) or when connected to an RF infrastructure to allow real time interaction between the host software and portable data collection and printing devices. All data input sent to the host system software is preferably by bar code scan to minimize human error. All labels are produced on an “as needed” basis as determined by the host system. This ensures that only correct labels are applied to the boxes, containers, pallets, and the like. This real time communication allows the host system software to monitor the packing, handling, and shipping label generation on all aspects of the selecting, packing, and shipping processes. In addition, a verification requirement of having an operator scan the exact serial numbers that the software is asking for when packing a shipment allows the system to determine the type of label needed and produce the correct label for each pallet.

By using a two-dimensional symbol such as PDF417 to mark individual parts with information such as a part number, a serial number, a part revision level, engineering changes, lot numbers, quality information, lot traceability, etc., the individual part becomes a portable database of information. This information is used to verify the proper packing of containers, to generate content lists and shipping labels, and is also used beyond the supplier by downstream users such as customer sites, dealers, repair shops, and insurance companies, etc. Hence, the more types of information that are put in the original two-dimensional part label, the more benefit to the downstream users who need to capture, collect, and process information that is contained within the two-dimensional label.

In this specification and claims the terms “component” and “container” are used as generic terms. Component refers to product, parts, boxes, containers, and the like that are packed into larger containers. Containers refer to anything into which items are packed. Therefore, containers refer to boxes, crates, pallets, trucks, railroad cars, and the like.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention.

What is claimed is:

1. A product packing validation system comprising:
a processor;
a memory in communication with said processor;
a component label reading device suitable for inputting component data from a machine readable component label, said reading device in communication with said processor; and
wherein said processor increments a counter when a component label is scanned, compares said counter to a predetermined limit number, and generates a done signal when said counter equals said limit number.

2. The product packing validation system according to claim 1, wherein said processor compares a portion of said component data to packing list data and activates an alarm signal if said component data is not consistent with said packing list data.

3. The product packing validation system according to claim 1, further comprising a labeling unit that produces a container label responsive to a command from said processor and wherein said processor generates said command only when a packing process is verified complete.

4. The product packing validation system according to claim 1, wherein said component label contains at least three items from the group consisting of a part number, a serial number, a date of manufacture data, and a revision level.

5. The product packing validation system according to claim 4, wherein said component label contains at least one item from the group consisting of date of manufacture, time of manufacture, line number, shift number, and lot ID code.

6. The product packing validation system according to claim 1, wherein said component label is a two-dimensional symbology.

7. The product packing validation system according to claim 6, wherein said component label is a PDF417 two-dimensional bar code.

8. The product packing validation system according to claim 1, wherein said label reading device is a two-dimensional symbology scanner.

9. The product packing validation system according to claim 3, wherein said container label contains component data input from said component labels of components packaged inside of said container.

10. The product packing validation system according to claim 3, wherein said container label is a two-dimensional symbology.

11. The product packing validation system according to claim 3, further comprising a container label reading device suitable for inputting container data from a container label and said processor increments a container counter when a container label is scanned, compares said container counter to a predetermined limit number, and generates a done signal when said container counter equals said limit number.

12. The product packing validation system according to claim 11, wherein said processor compares a portion of said container data to packing list data and activates an alarm signal if said container data is not consistent with said packing list data.

13. The product packing validation system according to claim 11, further comprising a crate labeling unit that produces a crate label responsive to a command from said processor and wherein said processor generates said command only when a crate packing process is verified complete.

14. The product packing validation system according to claim 13, further comprising a crate label reading device suitable for inputting crate data from a crate label and said processor compares a portion of said crate data to shipping order data and activates an alarm signal if said crate data is not consistent with said shipping order data.

15. The product packing validation system according to claim 13, further comprising a pallet labeling unit that produces a pallet label responsive to a command from said processor and wherein said processor generates said command only when a pallet packing process is verified complete.

16. The product packing validation system according to claim 15, further comprising a pallet label reading device is suitable for inputting pallet data from a pallet label being loaded onto a transport and said processor compares a portion of said pallet data to shipping order data and activates an alarm signal if said crate data is not consistent with said shipping order data.

17. The product packing validation system according to claim 15, further comprising a master pallet labeling unit that produces a master pallet label responsive to a command from said processor and wherein said processor generates said command only when a customer order process is verified complete.

18. A component packing validation system comprising:
a processor;
a memory in communication with said processor;
a component label reading device suitable for inputting component data from a machine readable component label, said reading device in communication with said processor; and
wherein said processor compares a portion of said component data to packing list data and activates an alarm signal if said component data is not consistent with said packing list data.

19. The component packing validation system according to claim 18, wherein said processor increments a counter when a component label is scanned, compares said counter to a predetermined limit number, and generates a done signal when said counter equals said limit number.

20. A method of validating packing and shipping operations comprising the steps of:
(a) labeling each component to be placed into a container with a component label;
(b) scanning the label on a component immediately prior to the component being packed into the container;
(c) automatically verifying that the component is correctly being packed into the container using information scanned from said label; and,
(d) notifying the packing operator if the component should not be packed.

21. The method of validating packing and shipping operations according to claim 20, further comprising the steps of:
(e) incrementing a component count for the container if the component is correctly packed into the container;
(f) repeating steps (b) through (e) until the component count for the container has reached a predetermined limit; and,
(g) generating a container label when the container packing process is complete and verified.

22. The method of validating packing and shipping operations according to claim 20, wherein the component labels contain at least one item of data from the group consisting of component part number, component serial number, date of component manufacture, component revision level, date of manufacture, time of manufacture, line number, shift number, and lot ID code.

23. The method of validating packing and shipping operations according to claim 21, wherein the container label contains data extracted from said component labels.

24. The method of validating packing and shipping operations according to claim 23, wherein the step of generating a container label includes generating a container label that contains at least one item from the group consisting of component part number, component serial number, date of component manufacture, component revision level, date of manufacture, time of manufacture, line number, shift number, and lot ID code.

25. The method of validating packing and shipping operations according to claim 21, further comprising the steps of:
(h) scanning the container label immediately prior to the time the container is packed in a crate;
(i) automatically verifying that the container is correctly being packed into the crate based on the information scanned from said container label; and
(k) notifying the packing operator if the container to be packed into the crate is incorrect.

26. The method of validating packing and shipping operations according to claim 25, further comprising the steps of:
(l) incrementing a container count for the crate if the container is correctly packed into the crate;
(m) repeating steps (b) through (l) until the container count for the crate has reached a predetermined limit; and
(o) generating a crate label when the crate packing process is complete and verified.

27. The method of validating packing and shipping operations according to claim 20, wherein said component label contains a portable database.

28. The method of validating packing and shipping operations according to claim 21, wherein said container label contains a two-dimensional symbology.

29. The method of validating packing and shipping operations according to claim 28, further comprising the step of a downstream user scanning said component label to extract data about said component.

30. The method of validating packing and shipping operations according to claim 29, wherein said component label contains at least one item from the list consisting of component part number, component serial number, date of component manufacture, component revision level, date of manufacture, time of manufacture, line number, shift number, and lot ID code.

31. A method of verifying packing operations comprising the steps of:
(a) labeling components with a machine-readable component label, said component label containing component data about the component on which the label is carried;
(b) labeling a container in which the components are contained with a machine readable container label containing data about the components contained therein;
(c) shipping the container;
(d) scanning the container label by a downstream user to extract the data pertaining to the component contents of the container; and,
(e) scanning the component labels by the downstream user to extract the component data and to verify the actual contents of the container against the data in the container label.

32. The method of verifying packing operations according to claim 31, wherein said machine readable component label contains at least one item of data from the group consisting of component part number, component serial number, date of component manufacture, component revision level, date of manufacture, time of manufacture, line number, shift number, and lot ID code.

33. A method of communicating parts data comprising the steps of:
(a) labeling a part with a machine-readable part label, said part label containing data about the part on which the label is carried;
(b) shipping the part to customer; and
(c) scanning the part label by a downstream user to extract the data about the part.

34. A method of communicating parts data according to claim 33, wherein said part label contains at lest one item of data from the group consisting of part number, serial number, date of manufacture, revision level, date of manufacture, time of manufacture, line number, shift number, and lot ID code.
